(19) United States
(12) Patent Application Publication
(10) Pub. No.: US 2023/0259341 A1
(43) Pub. Date: Aug. 17, 2023

(54) DISTRIBUTABLE RUNTIME SNAPSHOTS

(71) Applicants: Shiyu Zhang, Shanghai (CN); Junyong Ding, Shanghai (CN); Tao Pan, Shanghai (CN)

(72) Inventors: Shiyu Zhang, Shanghai (CN); Junyong Ding, Shanghai (CN); Tao Pan, Shanghai (CN)

(21) Appl. No.: 18/308,595

(22) Filed: Apr. 27, 2023

(30) Foreign Application Priority Data
Mar. 31, 2023 (WO) PCT/CN2023/085409

(51) Int. Cl. G06F 8/41

(52) U.S. Cl. CPC G06F 8/451

(57) ABSTRACT

A cloud service computing system can provide a runtime snapshot for an application in response to a request from a client computing system for the application. A cloud service computing system executes the application to an execution state and creates a snapshot that includes information indicating the application objects created by the application during execution of the application and the state of the application objects at the execution state. The snapshot further includes bytecode for the application and may also include configuration settings for the runtime under which the application was executed by the cloud service computing system to generate the snapshot. The client computing system can place the application in a ready to service state by initializing a managed heap with the bytecode and the heap objects based on information contained in the snapshot and placing the heap objects into a state indicated by information contained in the snapshot.

### BACKGROUND

This application claims the benefit of priority under 35 U.S.C. § 119(e) to PCT International Application Serial No. PCT/CN2023/085409 filed on Mar. 31, 2023 and entitled “Distributable Runtime Snapshots”. The prior application is hereby incorporated by reference in its entirety.

Software as a Service (SaaS) is a cloud-based service that provides applications to users on demand. The distribution of SaaS applications can differ from the traditional software distribution model in which an application is compiled into various binary files, each binary file capable of executing on a specific platform, and the appropriate binary file distributed to an end user via binary file pre-installation on a computing device or through download of the binary file over a network. In the SaaS distribution model, cross-platform source code for an SaaS application can be distributed to end users, with the end user's client computing system compiling the distributed source code into machine code that is executable by the client computing system.

### BRIEF DESCRIPTION OF THE DRAWINGS

FIG. 1 illustrates an example cloud-based application distribution model based on the distribution of application source code.

FIG. 2 illustrates an example cloud-based application distribution model based on the distribution of application snapshots.

FIG. 3 illustrates an example application snapshot distribution model that is compatible with application source code distribution.

FIG. 4 is a block diagram of an example client computing system for bringing an application to a ready to service state from an application snapshot.

FIG. 5 is a block diagram of an example cloud service computing system for generating application snapshots.

FIG. 6 is an example method of generating and providing an application snapshot.

FIG. 7 is an example method of receiving an application snapshot and executing an application associated with the application snapshot.

FIG. 8 is a block diagram of an example computing system within which the technologies described herein can be utilized.

FIG. 9 is a block diagram of an example processor unit to execute computer-executable instructions as part of implementing technologies described herein.

### DETAILED DESCRIPTION

Cloud-based services continue to gain popularity in both private and enterprise domains. These services are designed to provide easy and affordable access to applications and resources, without the need for internal infrastructure or hardware on the part of end users. One cloud service type is known as Software as a Service (SaaS), which serves applications to users over a network, typically the Internet. An application provided by SaaS is typically distributed to end users in the form of cross-platform (or portable) source code that the end user's client computing system compiles into executable machine code (a binary file) that can be executed by the end user client computing system. This differs from the distribution of native applications in various computing system platforms in which an application developer makes various binary files of the application available, each binary file being executable by a specific computing system platform, and an end user downloads the appropriate binary file for their platform, or the application comes pre-installed on an end user client device. The SaaS platform agnostic approach extends to other cloud-based services and allows users to store, access, share, and secure data in the cloud regardless of platform and/or operating system they may be using.

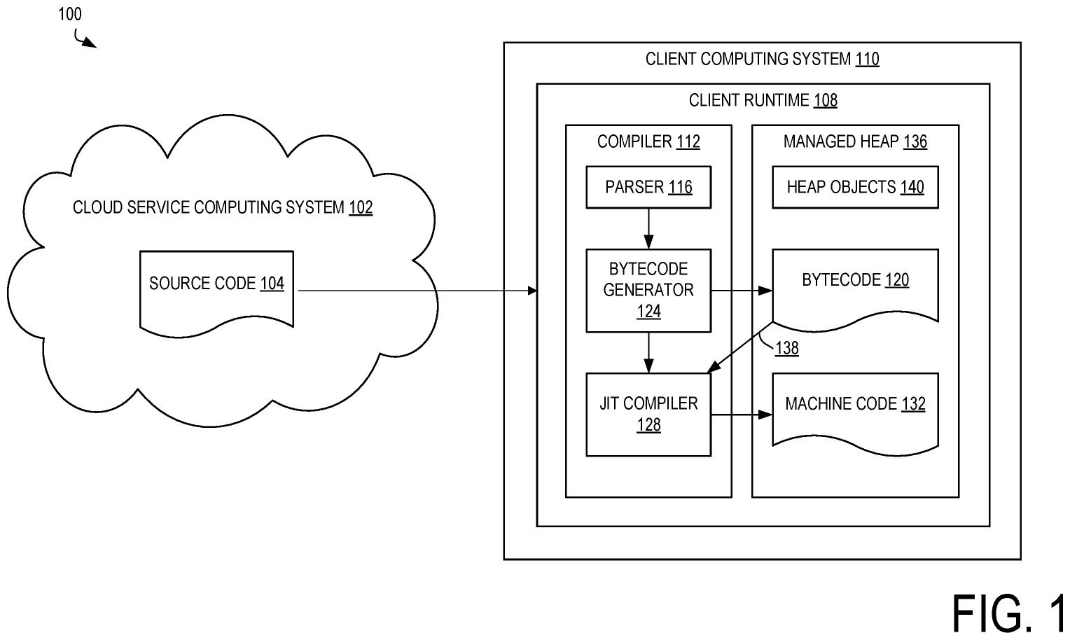

FIG. 1 illustrates an example cloud-based application distribution model based on the distribution of application source code. The model 100 comprises a cloud service computing system 102 in communication with a client computing system 110. In response to a request by the client computing system 110 for an application available as a cloud service, the cloud service computing system 102 distributes source code 104 for the application to a client runtime (or script engine) 108, such as Chrome runtime, operating on the client computing system 110. The source code 104 can be in a cross-platform source code format, such as JavaScript (.js) or WebAssembly text format (.wat). Compilation of the source code 104 by a compiler 112 comprises parsing of the source code 104 by a parser 116, generation of bytecode 120 by a bytecode generator 124, and compilation of bytecode 120 by a JIT (just-in-time) compiler 128 to machine code 132 that is executed by the client computing system 110. The JIT compiler 128 utilizes profiling data 138 representing the performance of machine code 132 executing on the client computing system 110 to determine if portions of the bytecode 120 are to be recompiled by the JIT compiler 128 to generate recompiled machine code 132 that is more optimized for the client computing system platform to improve application performance. The bytecode 120 and the machine code 132 are part of the client runtime's managed heap 136, which also contains heap application objects 140 generated during execution of the machine code 132.

The application code distribution model illustrated in FIG. 1 may be subject to one or more of the following drawbacks. First, the startup experience may be slow and unpredictable due to network issues. The startup times for native applications pre-installed on an end user client computing system are predictable and relatively short, depending on the hardware capability of the end user client computing system. However, cloud services such as SaaS applications need to be requested over a network for every startup of an application, which means the startup experience at the client side for an SaaS application can be highly dependent on the network quality. Thus, user experience could suffer when network quality is poor and/or when the size of the SaaS application source code is large.

Second, client computing system resources may be wasted due to repetitive parsing and compilation of application source code. Referring back to FIG. 1, after the source code 104 arrives at the client computing system 110, it needs to be parsed and compiled by the client runtime's parser 116 and bytecode generator 124 before it can be executed. If a user opens multiple runtime sessions (e.g., Chrome tabs) to request the same cloud service (e.g., an office productivity application), the client computing system 110 requests, parses, and compiles the same application source code 104 repeatedly. Repetitive parsing and compilation of the same source code can be a waste of client computing system resources.

Third, using the same client runtime configuration for various applications may result in sub-optimal application performance. The client runtime 108 has its own managed heap 136 to serve and isolate execution of an application from the cloud service computing system 102. The heap 136 is typically created and initialized before an application is requested from a cloud service computing system 102. Thus, the client runtime 108 can lack knowledge of a requested application and serve various kinds of cloud service applications with the same client runtime configuration. This can result in sub-optimal runtime performance for a set of cloud service applications running on multiple identical client runtimes on a client computing system 110.

Various approaches have been utilized to try to address these drawbacks, but these approaches can have their own disadvantages. First, some existing browsers utilize local storage to store source code and corresponding bytecode for scripts running on a webpage so that they can be reused when a user accesses the webpage in the future. The local storage of source code and bytecode can reduce the startup time of frequently visited websites. However, the local storing of webpage scripts and bytecodes is subject to storage limitations. For example, the V8 JavaScript engine may cache the bytecode for only top-level functions and some of these bytecodes may get flushed before getting stored locally due to garbage collection heuristics.

Second, startup snapshots can be used to reduce the startup time for runtimes, which can incur a large startup burden. For example, the V8 JavaScript engine needs to set up its global object and all of its built-in functionality (e.g., math functions, regular expression engine) in its heap every time a new runtime context is created. The use of a startup snapshot mechanism to deserialize a previously prepared V8 JavaScript engine snapshot directly into the heap saves the startup time of creating the runtime context from scratch. A startup snapshot is determined and created by a script engine embedder like Chrome. Additional library scripts could be added to the snapshot by the embedder to speed up the embedder application startup. However, runtime startup snapshots still lack the information for applications that a user may want to download from the cloud.

Third, JIT compilers can take advantage of knowledge indicating how machine code is performing on a client computing system to recompile portions of executing machine code to improve code performance, thereby allowing for a client computing system to execute machine code for an application that is more optimized than machine code compiled prior to execution of an application at the client computing system. A dynamic script language like JavaScript must be interpreted or compiled on the fly by the runtime (or script engine). The runtime needs to handle many dynamics (like the type of variables, the signature of functions, etc.) caused by the nature of dynamic language, which is a bottleneck of runtime performance. Thus, modern script engines can apply a multi-tier compiler technique to profile the characteristic of a workload at runtime during the low-tier execution (bytecode execution) and tier-up the hot functions (those functions that are frequently executed) to a JIT compiler with the profile to guide implementing speculative optimizations. JIT profiles are critical to the runtime performance of dynamic script languages, but runtime configurations are usually determined at runtime startup, which is before a JIT profile would be available. Thus, there are no hints available to the runtime to customize its configuration for a particular cloud service application it is going to execute.

Disclosed herein are distributable runtime snapshots. A cloud service computing system can run an application prior to it being requested by a client computing system and create a snapshot of a specific runtime context for the application. Instead of distributing the source code to a requesting client computing system, the cloud service provider can provide the snapshot of the application (application snapshot) to the client computing system. The client computing system can initialize a runtime based on the received application snapshot and pick up execution of the application from an execution state captured by the snapshot. The client computing system can store received application snapshots locally, which it can retrieve and use for initialization of new runtimes for execution of the application when a user next requests the cloud-based application associated with the locally-stored application snapshot. A cloud service provider can generate multiple snapshots available for a particular application with the various snapshots representing, for example, the application executed to different execution states and/or the application executed under different runtime configurations. The runtime configurations and/or the execution states for the various snapshots can be based on user requests, user feedback, or a set of predetermined runtime configurations or execution states that a cloud service provider may decide are likely to be requested by or applicable to end users.

The distributable runtime snapshots disclosed herein can improve the end user experience by providing a fast and stable startup for a SaaS application. For example, snapshot files are likely to be smaller than source code files for the same application (V8 JavaScript startup snapshots are about 30% smaller than the corresponding source code), which saves network transmission time. Further, initializing a runtime based on a snapshot (snapshot deserialization) is faster than compiling and executing the corresponding source code. For example, V8 JavaScript snapshot deserialization time is about 20 times faster than compilation and execution time for the equivalent source code. Moreover, starting up an application through the deserialization of a locally stored snapshot does not incur the time penalty of having to receive the application snapshot over a network, which can result in the user experiencing a startup time that approaches that of a native application. Furthermore, utilizing locally stored snapshots for application startup can save client computing system power consumption by avoiding redundant parsing and compilation when the user makes future requests for an application. Moreover, a cloud service provider can take advantage of client computing system's runtime capabilities by generating a snapshot under runtime configurations that match client system capabilities.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or in any other manner. “Connected” may indicate elements are in direct physical or electrical contact with each other and “coupled” may indicate elements co-operate or interact with each other, but they may or may not be in direct physical or electrical contact. Furthermore, the terms “comprising,” “including,” “having,” and the like, as used with respect to embodiments of the present disclosure, are synonymous.

In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

As used herein, the term “integrated circuit component” refers to a packaged or unpacked integrated circuit product. A packaged integrated circuit component comprises one or more integrated circuit dies mounted on a package substrate with the integrated circuit dies and package substrate encapsulated in a casing material, such as a metal, plastic, glass, or ceramic. In one example, a packaged integrated circuit component contains one or more processor units mounted on a substrate with an exterior surface of the substrate comprising a solder ball grid array (BGA). In one example of an unpackaged integrated circuit component, a single monolithic integrated circuit die comprises solder bumps attached to contacts on the die. The solder bumps allow the die to be directly attached to a printed circuit board. An integrated circuit component can comprise one or more of any computing system component described or referenced herein or any other computing system component, such as a processor unit (e.g., system-on-a-chip (SoC), processor core, graphics processor unit (GPU), accelerator, chipset processor), I/O controller, memory, or network interface controller.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the software or firmware instructions are not actively being executed by the system, device, platform, or resource.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

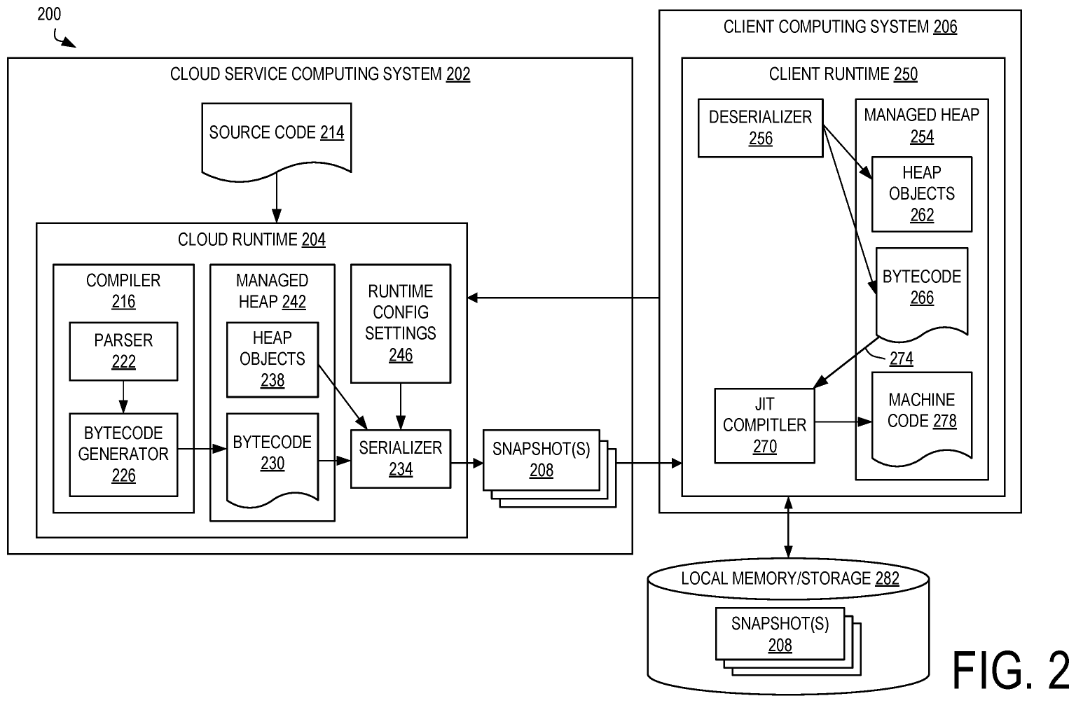

FIG. 2 illustrates an example cloud-based application distribution model based on the distribution of application snapshots. The model 200 comprises a cloud service computing system 202 in communication with a client computing system 206. In some embodiments, the client computing system 206 is a computing system that is in communication with the cloud service computing system 202 over one or more networks and the systems can thus be considered to be remote to each other. The cloud service computing system 202 comprises a cloud runtime 204 that generates one or more snapshots 208 for an application. To generate the snapshots 208, the cloud service computing system 202 executes an application having source code 214 with a cloud runtime 204 and executes the application to an execution state.

The compiler 216 of the cloud runtime 204 comprises parser 222 and bytecode generator 226 that do not tier-up hot functions of the application into a JIT compiler to generate machine code that is more optimized to run on the cloud service computing system 202. Instead, execution of the application stays with bytecode 230 generated by the bytecode generator 226. Because snapshots 208 may be distributed to client computing systems 206 that have different hardware platforms, portable bytecode is included in the snapshots 208. A serializer 234 generates application snapshots 208 through serialization of the bytecode 230 and heap objects 238 created during execution of the application and stored in the managed heap 242 by the cloud runtime 204. The serializer 234 further serializes the state of the heap objects 238 at the execution state for inclusion in the application snapshots 208.

During execution of an application by the cloud runtime 204, the managed heap 242 grows as more application objects are created and used by the application. The heap objects 238 comprise these application objects along with the application objects created by the cloud runtime 204 prior to execution of the application. The execution state at which the cloud runtime 204 ceases execution of the application and that is reflected in the application snapshot can be a pre-determined execution state or a dynamically determined execution state determined by the cloud runtime 204 as it executes the application. The pre-determined execution state can be defined by, for example, the cloud runtime 204 executing the application based in response to a set of inputs specified in an input file. The dynamically determined execution state can be determined by the cloud runtime 204 determining that execution of the application has reached a stable state, which the cloud runtime 204 can determine by, for example, that no new heap objects have been generated for a threshold amount of time during execution and/or a threshold percentage of the bytecode 230 has been executed. The serializer 234 generates a snapshot 208 and serialize the heap objects 238 and bytecode 230 into a runtime snapshot (or application snapshot 208) once execution of the application has reached the (pre-determined or dynamically determined) execution state.

A snapshot 208 can comprise the bytecode 230 or information from which the bytecode 230 can be derived (if, for example, the serializer 234 encrypts or compresses the bytecode) and information indicating application objects created prior to or during execution of the bytecode and object state information indicating the state of the individual application objects at the execution state.

In some embodiments, a user can request an application snapshot for an application executed to a specific execution state. The cloud service computing system 202 can receive the requested execution state for an application in a request from the client computing system 206 and the requested execution state can be used as a pre-determined execution state for generating an application snapshot 208. The requested execution state can be defined by, for example, a threshold of heap objects created and/or a threshold of bytecode for the application having been executed. Alternatively, a requested execution state can be defined by a set of input commands supplied by the client computing system to be fed to the application during execution of the application by the cloud service computing system 202 for snapshot generation purposes.

In some embodiments, the cloud service computing system 202 can receive user feedback on whether the execution state reflected in an application station was sufficiently stable. If not, the cloud service computing system 202 can provide an application snapshot 208 that reflects a different execution state in response to future requests for the application. The different execution states can be, for example, one in which more heap objects have been generated and/or more of the bytecode has been executed relative to the execution state that user feedback indicated as not being sufficiently stable. In some embodiments, as discussed in greater detail below, a cloud service computing system 202 may provide application source code instead of an application snapshot in response to receiving user feedback that an application snapshot is not associated with a stable execution state of the application.

In some embodiments, the serializer 234 can further serialize runtime configuration settings 246 that specify one or more settings of the cloud runtime 204 in which the application was executed to generate a particular snapshot 208 and include the serialized configuration settings 246 in the snapshot. In some embodiments, an application can be executed by the cloud runtime 204 under multiple different runtime configuration settings 246 to generate multiple snapshots 208. In some embodiments, a request from a client computing system 206 for an application can comprise one or more runtime configuration settings under which the application is to be executed at the client computing system 206 and the cloud service computing system 202 can distribute a snapshot 208 that has runtime configuration settings that match (or most closely match) the client runtime settings in the request.

In other embodiments, the runtime configuration settings 246 can be determined by the cloud runtime 204 as it executes an application. That is, the runtime configuration settings 246 can comprise runtime settings that have been tuned by the cloud runtime 204 during execution of the application to improve application runtime performance. These cloud runtime-determined runtime configuration settings can be serialized in a snapshot 208 and the client computing system 206 can set its client runtime settings to match those provided in a received snapshot 208.

Examples of runtime configuration settings that can be included in a snapshot include heap garbage collection heuristics (or garbage collection settings, such as information indicating what type of garbage collection algorithm is to be used and settings for the garbage collection algorithm), multi-tier compiler tiering settings (e.g., amount of code that can be compiled by a JIT compiler to improve code performance), memory configuration settings (e.g., how much memory is allocated to the application), and function inlining (function expansion) heuristics (or function inlining settings, such as the maximum size of a function to be inlined).

The serializer 234 can use any approach to convert heap objects, bytecode, and configuration settings into a format that can be distributed to client computing systems as a stream of data.

In response to receiving a request for an application from the client computing system 206, the cloud service computing system 202 can provide an application snapshot associated with the application to the client computing system 206. The request from the client computing system 206 can indicate the requested application without indicating whether the cloud service computing system 202 is to provide an application snapshot or application source code. In some embodiments, as described above, the application request from the client computing system 206 can comprise one or more requested runtime configuration settings and/or an application execution state for which an application snapshot is to be provided. In some embodiments, the cloud service computing system 202 can distribute the snapshot 208 generated in the cloud runtime 250 that reflects an execution state that matches (or most closely matches) the requested execution state.

After an application snapshot 208 is received at the client computing system 206, an embedder of the client runtime 210 first reads any runtime configuration from the snapshot 208 and then starts up a runtime process with those configurations. Instead of a heap initialized to a blank context, the heap 254 is populated (by, for example, a deserializer 256 that operates on a received snapshot 208) with heap objects 262 described by and bytecode 266 contained in the snapshot 208. The deserializer, based on the object state information in the snapshot, places the heap objects 262 in the state that the objects were in when execution of the application at the cloud service computing system 202 reached the execution state. After population of the managed heap 254, the application is in a ready-to-service state without the client computing system 206 having had to parse and compile application source code. Once the application is operating in the client runtime 250, a JIT compiler 270 can compile portions of the bytecode 266 based on information 274 indicating performance of the bytecode 266 to generate machine code 278 that is more optimized for performance on the client computing system 206. In some embodiments, the client runtime 250 can comprise a parser and a bytecode generator to generate bytecode 266 for portions of an application provided in source code format in response to an application request.

In some embodiments, the client computing system 206 can store received snapshots 208 in local memory or storage 282. The local memory or storage 282 can be any computing system memory or storage, such as any non-volatile memory or storage (e.g., flash memory, solid-state drives, magnetic disks, or tape drives). If a user requests a cloud application for which a snapshot is stored locally, the client computing system 206 can load the snapshot from the local storage. This can provide for a stable application startup experience as application startup is not subject to, for example, network issues. In some embodiments, the client computing system 206 can perform staleness verification on a snapshot for a requested application to ensure that the snapshot is not out of date.

As discussed above, advantages of a cloud service computing system providing application snapshots instead of application source code to a requesting client computing system include replacing the parsing, compiling, and executing (to construct the application's heap objects) application source code to construct the application's initial state with initialization of a heap via deserialization of an application snapshot. The time-savings for the first startup of an application on a client computing system is estimated to be similar to that of deserializing a JavaScript V8 startup snapshot, which is roughly 10-20×quicker than starting up an application by parsing, compiler, and executing, depending on application source code complexity and scale.

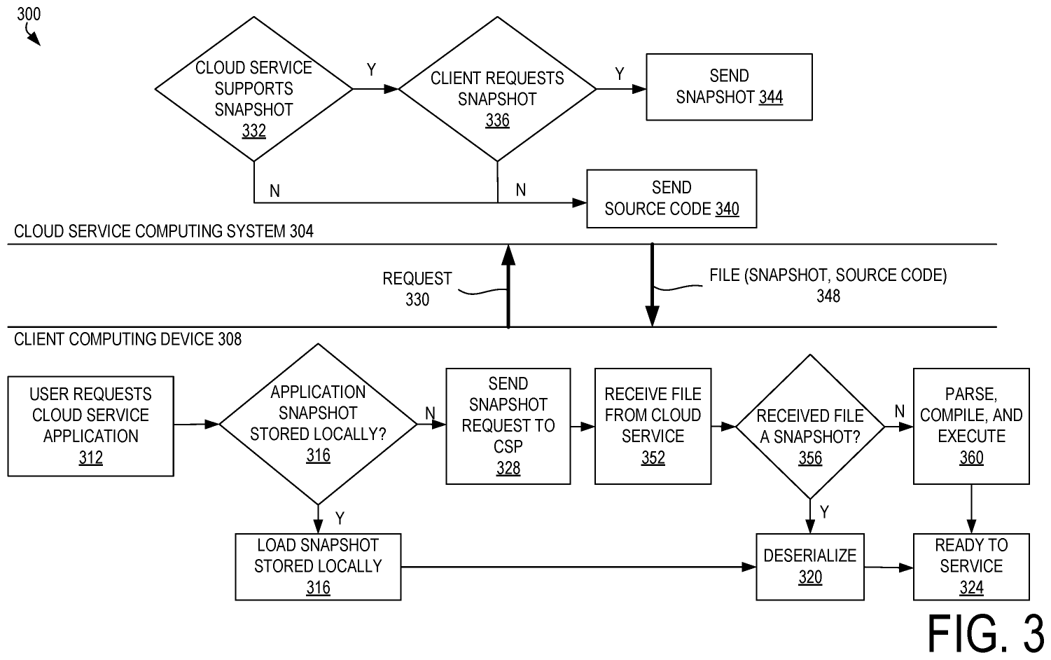

FIG. 3 illustrates an example application snapshot distribution model that is compatible with application source code distribution. The model 300 comprises a cloud service computing system 304 in communication with a client computing system 308 in which the cloud service computing system 304 determines whether to supply an application snapshot or application source code to the client computing system 308 in response to an application request from the client computing system 308. Starting on the client computing system 308 side, at 312, a user requests a cloud service application. At 316, the client computing system 308 determines whether a snapshot of the requested application is stored locally at the client computing system 308. If so, at 316, the application snapshot is retrieved from local memory or storage, the snapshot is deserialized at 320, and the application is placed in a ready to service state at 324. If not, at 328, the client computing system 308 sends an application snapshot request 330 to the cloud service computing system 304.

Jumping to the cloud service computing system 304 side, if the cloud service computing system 304 does not support application snapshots (332) or an application request from a client computing system 308 is a request for application source code instead of a snapshot (336), the cloud service computing system 304 sends application source code 348 to the client computing system 308 at 340. If the cloud service computing system 304 supports application snapshots (336) and the request is for an application snapshot, the cloud service computing system 304 sends an application snapshot 348 to the client computing system 308 at 344.

Returning to the client computing system 308 side, application source code or snapshot 348 is received from the cloud service computing system 304 at 352. If, at 356, the received file 348 is an application snapshot, the snapshot is deserialized at 320. If the file 344 is application source code, the source code is parsed, compiled, and executed at 360. In either event, after deserialization of the application snapshot or parsing, compiling, and execution of the application source code, the application is in a ready to service state at 324.

In some embodiments, as discussed above, a cloud service computing system 304 can provide application source code instead of an application snapshot, even if an application snapshot is available. A cloud service computing system 304 may provide source code instead of a snapshot for an application, for example, in response to receiving feedback from a user that has previously received the application snapshot that the execution state associated with the application snapshot is unstable.

In some embodiments, a cloud computing device can retrieve a first portion of an application from local memory or storage and receive a second portion of the application from a cloud service provider, either as source code or a snapshot. If the client computing system receives source code for the second portion of the application from the cloud service provider, the client computing system parses, compiles, and executes the source code and deserializes the application snapshot for the first portion of the application to place the application in a ready to service state. If the client computing system receives an application snapshot for the second portion of the application, the client computing system deserializes the application snapshots for the first and second portions to put the application in a ready to service state.

The scenario where a client computing system retrieves an application snapshot locally for a first portion of an application and source code or a snapshot for a second portion of the application could occur in some embodiments when, for example, the first portion is determined by the client computing system to not be stale and second portion of the application is determined to be stale. The staleness determination for portions of an application associated with a snapshot could be made by the client computing system and be based on information in the application snapshot indicating, for example, a date or a number of days since the snapshot was provided by a cloud service provider after which individual portions of the application are considered to be stale and a new snapshot of the portion of the application is to be retrieved from the cloud service provider.

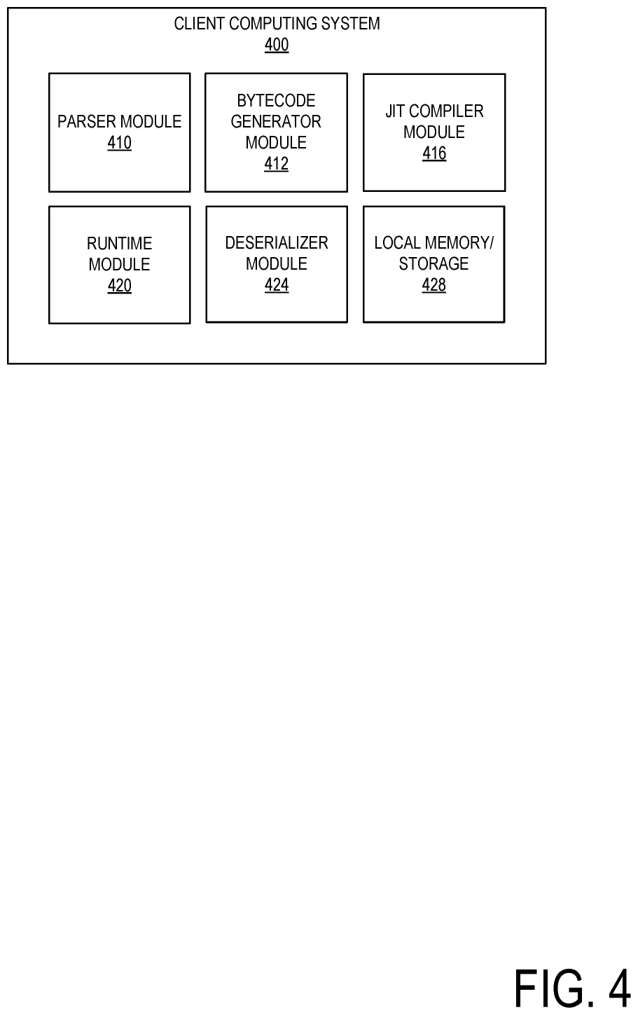

FIG. 4 is a block diagram of an example client computing system for bringing an application to a ready to service state from an application snapshot. The computing device 400 comprises a parser module 410 and a bytecode generator module 412 for parsing and compiling application source code should a portion of the application be received from a cloud service provider in source code format, a JIT compiler module 416 to compile portions of application machine code during execution of the machine code, a runtime module 420 to create and maintain a runtime within which an application can execute, a deserialization module 424 to initialize a managed heap with compiled code and heap objects contained in or indicated by information contained in an application snapshot (the heap objects placed in a state indicated by objection information located in the snapshot), and local memory or storage 428 to store application snapshots.

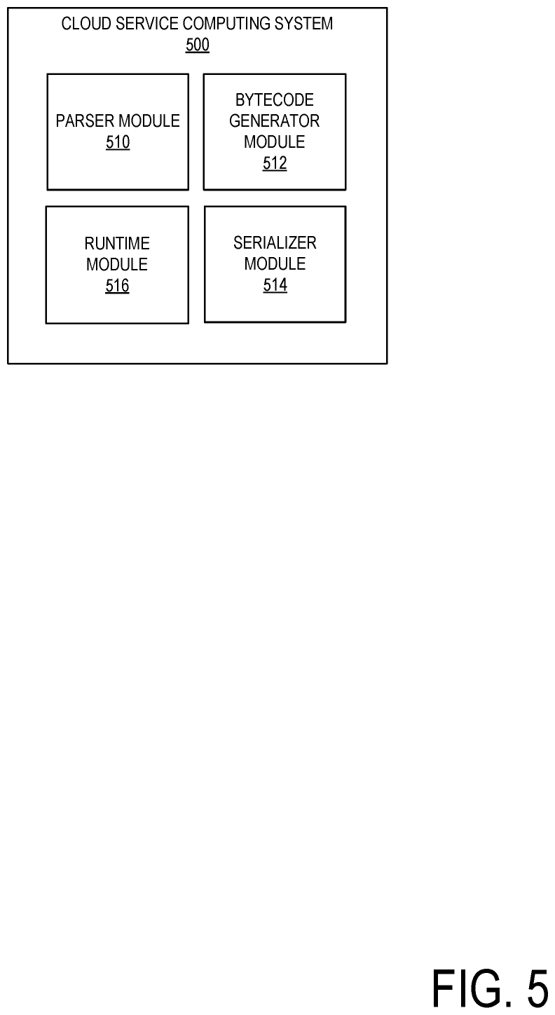

FIG. 5 is a block diagram of an example cloud service computing system for generating application snapshots. The cloud service computing system 500 comprises a parser module 510 and a bytecode generator module 512 for parsing and compiling application source code in application bytecode, a runtime module 516 to create and maintain a runtime within which an application can execute, and a serialization module 514 to create an application snapshot.

It is to be understood that FIGS. 4-5 illustrates one example of a set of modules that can be included in a client computing system and a set of modules that can be included in a cloud service provider. In other embodiments, a client computing system can have more or fewer modules than those shown in FIG. 4 and a cloud service computing system can have more or fewer modules than those shown in FIG. 5.

Further, separate modules can be combined into a single module, and a single module can be split into multiple modules. Moreover, any of the modules shown in FIG. 4 can be part of an operating system or a hypervisor of the client computing device 400, one or more software applications independent of the operating system or hypervisor, or operate at another software layer; and any of the modules shown in FIG. 5 can be part of an operating system or a hypervisor of the cloud service computing system 500, one or more software applications independent of the operating system or hypervisor, or operate at another software layer.

The modules shown in FIGS. 4-5 can be implemented in software, hardware, firmware, or combinations thereof. A computer device referred to as being programmed to perform a method can be programmed to perform the method via software, hardware, firmware, or combinations thereof.

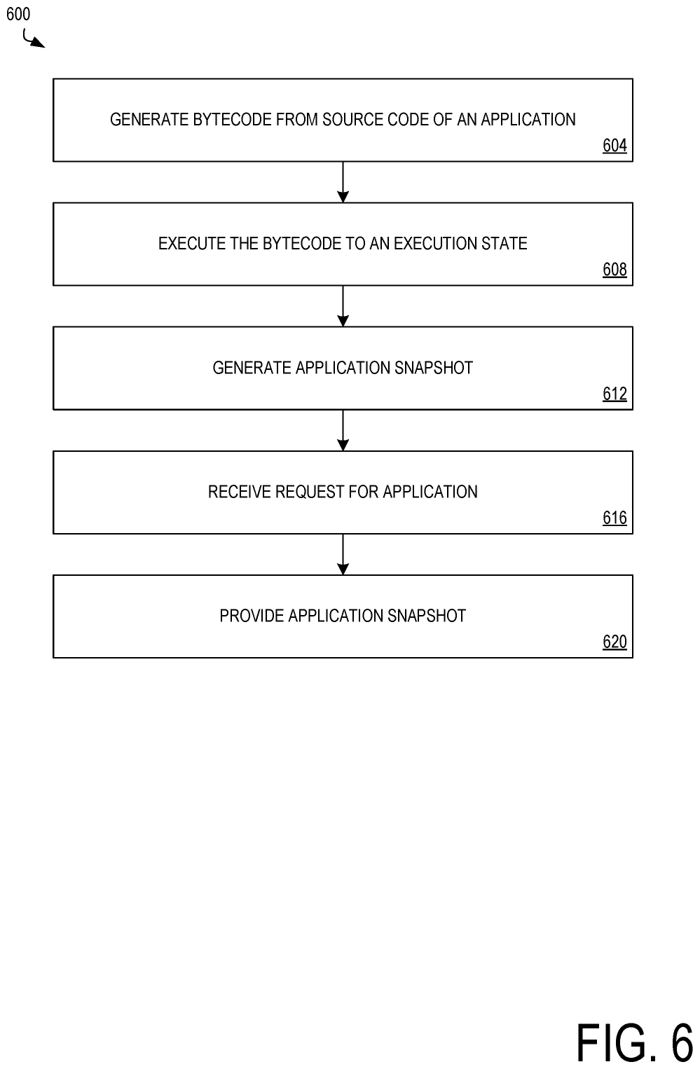

FIG. 6 is an example method of generating and providing an application snapshot. The method 600 can be performed by, for example, a server owned by a cloud service provider. At 604, at a first computing system, bytecode is generated from source code of an application. At 608, at the first computing system, the bytecode is executed to an execution state. At 612, at the first computing system an application snapshot is generated at the first computing system, the application snapshot comprising the bytecode; and object information indicating a plurality of objects created during execution of the bytecode and, for individual of the objects, object state information indicating a state of the individual object at the execution state. At 616, at the first computing system, a request for the application is received from a second computing system. At 620, the application snapshot is provided from the first computing system to the second computing system.

In other embodiments, the method 600 can comprise one or more additional elements. For example, the method 600 can further comprise executing, at the first computing system, the bytecode in a second runtime configured according to one or more second runtime configuration settings; generating, at the first computing system, a second application snapshot comprising: the bytecode or information from which the bytecode can be generated; and second object information indicating the plurality of objects and, for individual of the objects, second object state information indicating a state of the individual object in response to execution of the bytecode to the execution state in the second runtime; and providing, from the first computing system, the second application snapshot to the second computing system.

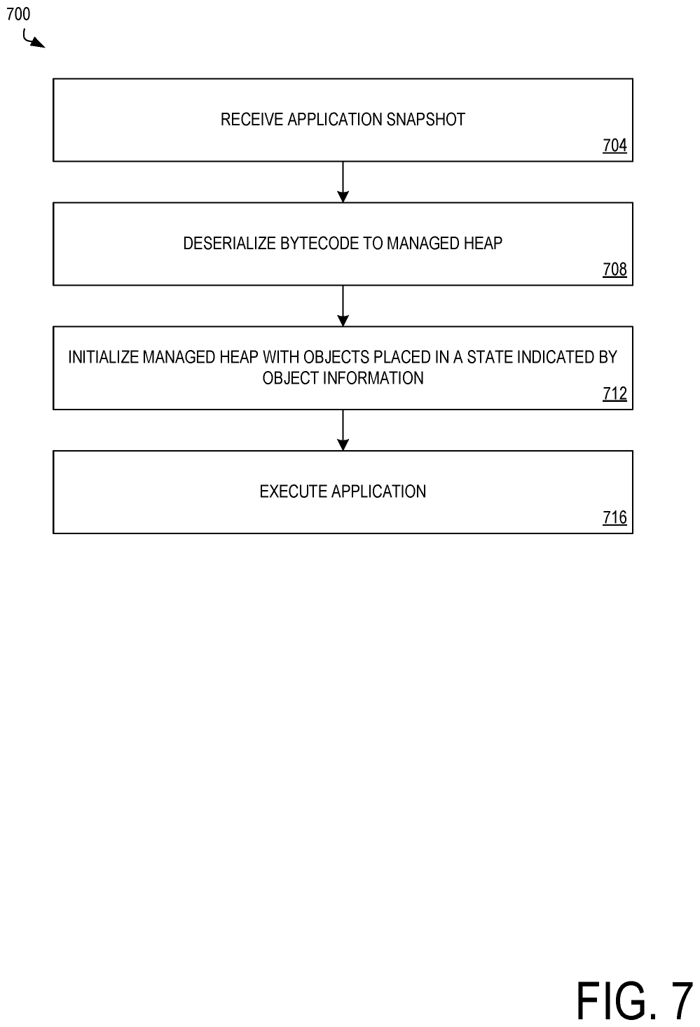

FIG. 7 is an example method of receiving an application snapshot and executing an application associated with the application snapshot. The method 700 can be performed by, for example, a laptop computer. At 704, at a first computing system, an application snapshot is received from a second computing system, the application snapshot comprising bytecode for an application or information from which the bytecode can be generated; and object information indicating a plurality of objects and, for individual of the objects, object state information indicating a state of the individual objects at an execution state of the application. At 708, at the first computing system, the bytecode is deserialized into a managed heap for execution by the first computing system. At 712, at the first computing system, the managed heap is initialized with the plurality of application objects, individual of the application objects placed in a state indicated by the object state information for the individual application object. At 716, at the first computing system, the application is executed from the execution state.

In other embodiments, the method 700 can comprise one or more additional elements. For example, the method 700 can further comprise configuring a runtime within which the application is to execute based on one or more configuration settings contained in the application snapshot. In another example, the method 700 can further comprise saving the application snapshot to memory or stage local to the first computing system. In yet another example, the method 700 can further comprise initializing, at the first computing system, a second heap of a second runtime with the plurality of objects and the object states of the individual application objects; and executing, at the first computing system, a second instance of the application in the second runtime from the execution state via execution of the machine code.

The technologies described herein can be performed by or implemented in any of a variety of computing systems, including mobile computing systems (e.g., smartphones, handheld computers, tablet computers, laptop computers, portable gaming consoles, 2-in-1 convertible computers, portable all-in-one computers), non-mobile computing systems (e.g., desktop computers, servers, workstations, stationary gaming consoles, set-top boxes, smart televisions, rack-level computing solutions (e.g., blade, tray, or sled computing systems)), and embedded computing systems (e.g., computing systems that are part of a vehicle, smart home appliance, consumer electronics product or equipment, manufacturing equipment). As used herein, the term “computing system” includes computing devices and includes systems comprising multiple discrete physical components. In some embodiments, the computing systems are located in a data center, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves).

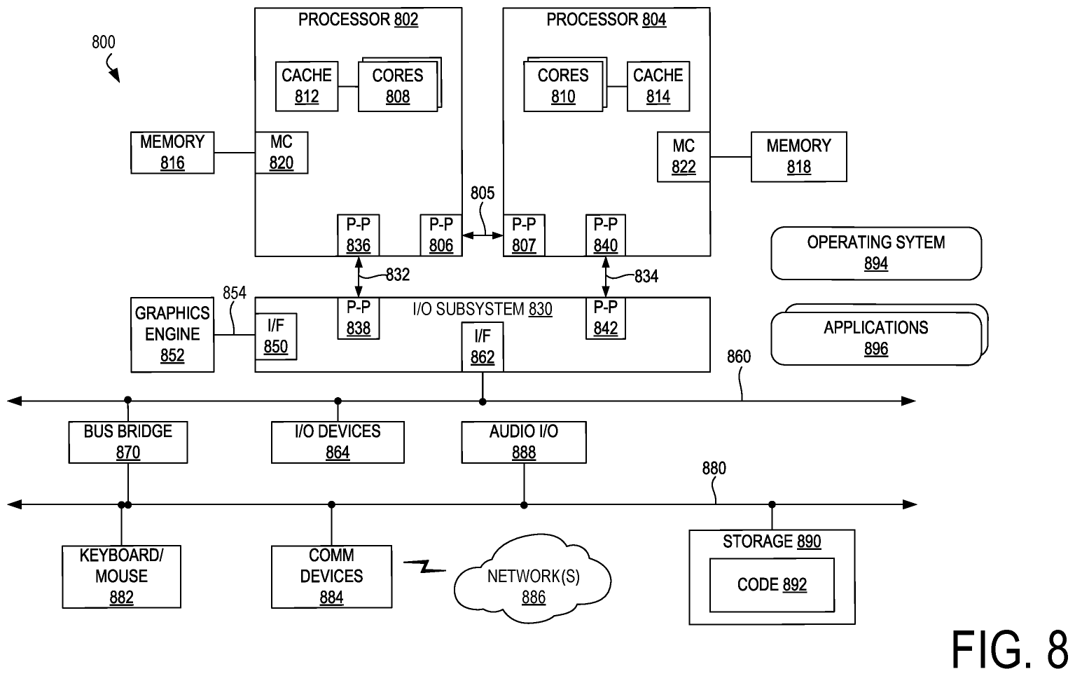

FIG. 8 is a block diagram of an example computing system in which technologies described herein may be implemented. Generally, components shown in FIG. 8 can communicate with other shown components, although not all connections are shown, for ease of illustration. The computing system 800 is a multiprocessor system comprising a first processor unit 802 and a second processor unit 804 comprising point-to-point (P-P) interconnects. A point-to-point (P-P) interface 806 of the processor unit 802 is coupled to a point-to-point interface 807 of the processor unit 804 via a point-to-point interconnection 805. It is to be understood that any or all of the point-to-point interconnects illustrated in FIG. 8 can be alternatively implemented as a multi-drop bus, and that any or all buses illustrated in FIG. 8 could be replaced by point-to-point interconnects.

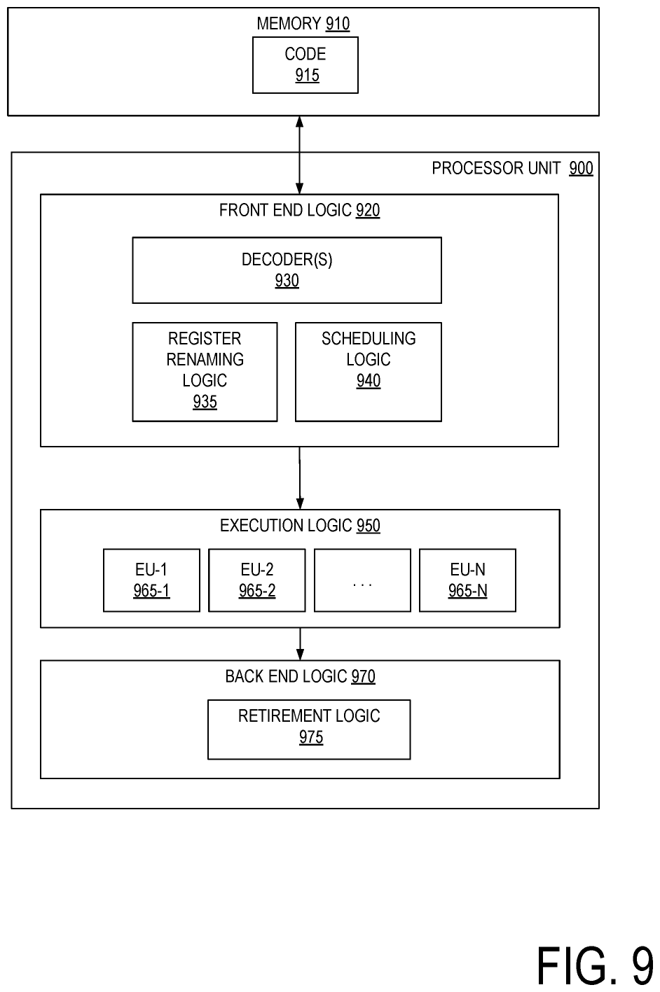

The processor units 802 and 804 comprise multiple processor cores. Processor unit 802 comprises processor cores 808 and processor unit 804 comprises processor cores 810. Processor cores 808 and 810 can execute computer-executable instructions in a manner similar to that discussed below in connection with FIG. 9, or other manners.

Processor units 802 and 804 further comprise cache memories 812 and 814, respectively. The cache memories 812 and 814 can store data (e.g., instructions) utilized by one or more components of the processor units 802 and 804, such as the processor cores 808 and 810. The cache memories 812 and 814 can be part of a memory hierarchy for the computing system 800. For example, the cache memories 812 can locally store data that is also stored in a memory 816 to allow for faster access to the data by the processor unit 802. In some embodiments, the cache memories 812 and 814 can comprise multiple cache levels, such as level 1 (L1), level 2 (L2), level 3 (L3), level 4 (L4) and/or other caches or cache levels. In some embodiments, one or more levels of cache memory (e.g., L2, L3, L4) can be shared among multiple cores in a processor unit or among multiple processor units in an integrated circuit component. In some embodiments, the last level of cache memory on an integrated circuit component can be referred to as a last level cache (LLC). One or more of the higher levels of cache levels (the smaller and faster caches) in the memory hierarchy can be located on the same integrated circuit die as a processor core and one or more of the lower cache levels (the larger and slower caches) can be located on an integrated circuit dies that are physically separate from the processor core integrated circuit dies.

Although the computing system 800 is shown with two processor units, the computing system 800 can comprise any number of processor units. Further, a processor unit can comprise any number of processor cores. A processor unit can take various forms such as a central processing unit (CPU), a graphics processing unit (GPU), general-purpose GPU (GPGPU), accelerated processing unit (APU), field-programmable gate array (FPGA), neural network processing unit (NPU), data processor unit (DPU), accelerator (e.g., graphics accelerator, digital signal processor (DSP), compression accelerator, artificial intelligence (AI) accelerator), controller, or other types of processing units. As such, the processor unit can be referred to as an XPU (or xPU). Further, a processor unit can comprise one or more of these various types of processing units. In some embodiments, the computing system comprises one processor unit with multiple cores, and in other embodiments, the computing system comprises a single processor unit with a single core. As used herein, the terms “processor unit” and “processing unit” can refer to any processor, processor core, component, module, engine, circuitry, or any other processing element described or referenced herein.

In some embodiments, the computing system 800 can comprise one or more processor units that are heterogeneous or asymmetric to another processor unit in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processor units in a system.

The processor units 802 and 804 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from the integrated circuit dies comprising the processor units. In some embodiments, these separate integrated circuit dies can be referred to as “chiplets”. In some embodiments where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Processor units 802 and 804 further comprise memory controller logic (MC) 820 and 822. As shown in FIG. 8, MCs 820 and 822 control memories 816 and 818 coupled to the processor units 802 and 804, respectively. The memories 816 and 818 can comprise various types of volatile memory (e.g., dynamic random-access memory (DRAM), static random-access memory (SRAM)) and/or non-volatile memory (e.g., flash memory, chalcogenide-based phase-change non-volatile memories), and comprise one or more layers of the memory hierarchy of the computing system. While MCs 820 and 822 are illustrated as being integrated into the processor units 802 and 804, in alternative embodiments, the MCs can be external to a processor unit.

Processor units 802 and 804 are coupled to an Input/Output (I/O) subsystem 830 via point-to-point interconnections 832 and 834. The point-to-point interconnection 832 connects a point-to-point interface 836 of the processor unit 802 with a point-to-point interface 838 of the I/O subsystem 830, and the point-to-point interconnection 834 connects a point-to-point interface 840 of the processor unit 804 with a point-to-point interface 842 of the I/O subsystem 830. Input/Output subsystem 830 further includes an interface 850 to couple the I/O subsystem 830 to a graphics engine 852. The I/O subsystem 830 and the graphics engine 852 are coupled via a bus 854.

The Input/Output subsystem 830 is further coupled to a first bus 860 via an interface 862. The first bus 860 can be a Peripheral Component Interconnect Express (PCIe) bus or any other type of bus. Various I/O devices 864 can be coupled to the first bus 860. A bus bridge 870 can couple the first bus 860 to a second bus 880. In some embodiments, the second bus 880 can be a low pin count (LPC) bus. Various devices can be coupled to the second bus 880 including, for example, a keyboard/mouse 882, audio I/O devices 888, and a storage device 890, such as a hard disk drive, solid-state drive, or another storage device for storing computer-executable instructions (code) 892 or data. The code 892 can comprise computer-executable instructions for performing methods described herein. Additional components that can be coupled to the second bus 880 include communication device(s) 884, which can provide for communication between the computing system 800 and one or more wired or wireless networks 886 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 802.11 standard and its supplements).

In embodiments where the communication devices 884 support wireless communication, the communication devices 884 can comprise wireless communication components coupled to one or more antennas to support communication between the computing system 800 and external devices. The wireless communication components can support various wireless communication protocols and technologies such as Near Field Communication (NFC), IEEE 1002.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM), and 5G broadband cellular technologies. In addition, the wireless modems can support communication with one or more cellular networks for data and voice communications within a single cellular network, between cellular networks, or between the computing system and a public switched telephone network (PSTN).

The system 800 can comprise removable memory such as flash memory cards (e.g., SD (Secure Digital) cards), memory sticks, Subscriber Identity Module (SIM) cards). The memory in system 800 (including caches 812 and 814, memories 816 and 818, and storage device 890) can store data and/or computer-executable instructions for executing an operating system 894 and application programs 896. Example data includes web pages, text messages, images, sound files, video data, application snapshots, application source code or other data sets to be sent to and/or received from one or more network servers or other devices by the system 800 via the one or more wired or wireless networks 886, or for use by the system 800. The system 800 can also have access to external memory or storage (not shown) such as external hard drives or cloud-based storage.

The operating system 894 can control the allocation and usage of the components illustrated in FIG. 8 and support the one or more application programs 896. The application programs 896 can include common computing system applications (e.g., email applications, calendars, contact managers, web browsers, messaging applications) as well as other computing applications, such parsers, bytecode generators, JIT compilers, serializers, and deserializers.

In some embodiments, a hypervisor (or virtual machine manager) operates on the operating system 894 and the application programs 896 operate within one or more virtual machines operating on the hypervisor. In these embodiments, the hypervisor is a type-2 or hosted hypervisor as it is running on the operating system 894. In other hypervisor-based embodiments, the hypervisor is a type-1 or “bare-metal” hypervisor that runs directly on the platform resources of the computing system 894 without an intervening operating system layer.

In some embodiments, the applications 896 can operate within one or more containers. A container is a running instance of a container image, which is a package of binary images for one or more of the applications 896 and any libraries, configuration settings, and any other information that one or more applications 896 need for execution. A container image can conform to any container image format, such as Docker®, Appc, or LXC container image formats. In container-based embodiments, a container runtime engine, such as Docker Engine, LXU, or an open container initiative (OCI)-compatible container runtime (e.g., Railcar, CRI-O) operates on the operating system (or virtual machine monitor) to provide an interface between the containers and the operating system 894. An orchestrator can be responsible for management of the computing system 800 and various container-related tasks such as deploying container images to the computing system 894, monitoring the performance of deployed containers, and monitoring the utilization of the resources of the computing system 894.

The computing system 800 can support various additional input devices, such as a touchscreen, microphone, camera, trackball, touchpad, trackpad, proximity sensor, light sensor, and one or more output devices, such as one or more speakers or displays. Any of the input or output devices can be internal to, external to, or removably attachable with the system 800. External input and output devices can communicate with the system 800 via wired or wireless connections.

The system 800 can further include at least one input/output port comprising physical connectors (e.g., USB, IEEE 1394 (FireWire), Ethernet, RS-232), a power supply (e.g., battery), a global satellite navigation system (GNSS) receiver (e.g., GPS receiver); a gyroscope; an accelerometer; and/or a compass. A GNSS receiver can be coupled to a GNSS antenna. The computing system 800 can further comprise one or more additional antennas coupled to one or more additional receivers, transmitters, and/or transceivers to enable additional functions.

It is to be understood that FIG. 8 illustrates only one example computing system architecture. Computing systems based on alternative architectures can be used to implement technologies described herein. For example, instead of the processors 802 and 804 and the graphics engine 852 being located on discrete integrated circuits, a computing system can comprise an SoC (system-on-a-chip) integrated circuit incorporating multiple processors, a graphics engine, and additional components. Further, a computing system can connect its constituent component via bus or point-to-point configurations different from that shown in FIG. 8. Moreover, the illustrated components in FIG. 8 are not required or all-inclusive, as shown components can be removed and other components added in alternative embodiments.

FIG. 9 is a block diagram of an example processor unit to execute computer-executable instructions as part of implementing technologies described herein. The processor unit 900 can be a single-threaded core or a multithreaded core in that it may include more than one hardware thread context (or “logical processor”) per processor unit.

FIG. 9 also illustrates a memory 910 coupled to the processor unit 900. The memory 910 can be any memory described herein or any other memory known to those of skill in the art. The memory 910 can store computer-executable instructions 915 (code) executable by the processor unit 900.

The processor unit comprises front-end logic 920 that receives instructions from the memory 910. An instruction can be processed by one or more decoders 930. The decoder 930 can generate as its output a micro-operation such as a fixed width micro-operation in a predefined format, or generate other instructions, microinstructions, or control signals, which reflect the original code instruction. The front-end logic 920 further comprises register renaming logic 935 and scheduling logic 940, which generally allocate resources and queues operations corresponding to converting an instruction for execution.

The processor unit 900 further comprises execution logic 950, which comprises one or more execution units (EUs) 965-1 through 965-N. Some processor unit embodiments can include a number of execution units dedicated to specific functions or sets of functions. Other embodiments can include only one execution unit or one execution unit that can perform a particular function. The execution logic 950 performs the operations specified by code instructions. After completion of execution of the operations specified by the code instructions, back-end logic 970 retires instructions using retirement logic 975. In some embodiments, the processor unit 900 allows out of order execution but requires in-order retirement of instructions. Retirement logic 975 can take a variety of forms as known to those of skill in the art (e.g., re-order buffers or the like).

The processor unit 900 is transformed during execution of instructions, at least in terms of the output generated by the decoder 930, hardware registers and tables utilized by the register renaming logic 935, and any registers (not shown) modified by the execution logic 950.

As used herein, the term “module” refers to logic that may be implemented in a hardware component or device, software or firmware running on a processor unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processor units, state machine circuitry, and/or firmware that stores instructions executable by programmable circuitry. Modules described herein may, collectively or individually, be embodied as circuitry that forms a part of a computing system. Thus, any of the modules can be implemented as circuitry, such as serializer circuitry and deserializer circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processor units capable of executing computer-executable instructions to perform any of the disclosed methods. As used herein, the term “computer” refers to any computing system, device, or machine described or mentioned herein as well as any other computing system, device, or machine capable of executing instructions. Thus, the term “computer-executable instruction” refers to instructions that can be executed by any computing system, device, or machine described or mentioned herein as well as any other computing system, device, or machine capable of executing instructions.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

As used in this application and the claims, the phrase “individual of” or “respective of” following by a list of items recited or stated as having a trait, feature, etc. means that all of the items in the list possess the stated or recited trait, feature, etc. For example, the phrase “individual of A, B, or C, comprise a sidewall” or “respective of A, B, or C, comprise a sidewall” means that A comprises a sidewall, B comprises sidewall, and C comprises a sidewall.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The following examples pertain to additional embodiments of technologies disclosed herein.

Example 1 includes a method comprising generating, at a first computing system, bytecode from source code of an application; executing, at the first computing system, the bytecode to an execution state; generating, at the first computing system, an application snapshot comprising the bytecode; and object information indicating a plurality of application objects created during execution of the bytecode and, for individual of the application objects, object state information indicating a state of the individual application object at the execution state; receiving, at the first computing system, a request for the application from a second computing system; and providing, from the first computing system, the application snapshot to the second computing system.

Example 2 includes the subject matter of Example 1, and wherein the request comprises information indicating a requested execution state of the application, the providing the application snapshot being performed in response to the first computing system determining that the requested execution state matches the execution state.

Example 3 includes the subject matter of Example 1, and wherein the execution state is a first execution state, the application snapshot is a first application snapshot, the object state information is first object state information indicating states of the individual application objects at the first execution state; the method further comprising executing, at the first computing system, the bytecode to a second execution state; generating, at the first computing system, a second application snapshot comprising the bytecode or information from which the bytecode can be generated; and the object information indicating the plurality of application objects and, for individual of the application objects, second object information indicating a state of the individual application object at the second execution state; and providing, from the first computing system, the second application snapshot to the second computing system.

Example 4 includes the subject matter of Example 3, and further including receiving, from the second computing system, information indicating the second execution state, the executing the bytecode to the second execution state and the generating the second application snapshot being performed in response to receiving the information indicating the second execution state.

Example 5 includes the subject matter of Example 1, and wherein the executing the bytecode is performed in a runtime configured according to one or more runtime configuration settings, the application snapshot further comprising information indicating at least one of the one or more runtime configuration settings.

Example 6 includes the subject matter of Example 5, and wherein the runtime is a first runtime, the one or more runtime configuration settings are one or more first runtime configuration settings, the application snapshot is a first application snapshot comprising first object state information indicating states of the application objects in response to executing the bytecode in the first runtime to the execution state, the method further comprising executing, at the first computing system, the bytecode in a second runtime configured according to one or more second runtime configuration settings; generating, at the first computing system, a second application snapshot comprising the bytecode or information from which the bytecode can be generated; and the object information indicating the plurality of application objects and, for individual of the application objects, second object state information indicating a state of the individual application objects in response to executing the bytecode in the second runtime to the second execution state; and providing, from the first computing system, the second application snapshot to the second computing system.

Example 7 includes the subject matter of Example 6, and wherein the request comprises information indicating one or more requested runtime configuration settings, the providing the first application snapshot being performed in response to the first computing system determining that the one or more requested runtime configuration settings match the first runtime configuration settings.

Example 8 includes the subject matter of Example 5, and further including receiving, from the second computing system, information indicating the one or more second runtime configuration settings, the executing the bytecode in the second runtime and the generating the second application snapshot being performed in response to receiving the information indicating the one or more second runtime configuration settings.

Example 9 includes the subject matter of any one of claims 5-8, wherein the one or more runtime configuration settings comprises a memory configuration setting.

Example 10 includes the subject matter of any one of claims 5-8, wherein the one or more runtime configuration settings comprises a heap garbage collection setting.

Example 11 includes the subject matter of any one of claims 5-8, wherein the one or more runtime configuration settings comprises a function inlining setting.

Example 12 includes the subject matter of any one of claims 5-8, wherein the one or more runtime configuration settings comprises a multi-tier compiler tiering setting.

Example 13 includes the subject matter of any one of claims 1-12, further comprising providing, from the first computing system, a portion of source code of the application to the second computing system.

Example 14 includes a method comprising receiving, at a first computing system, an application snapshot from a second computing system, the application snapshot comprising bytecode for an application or information from which the bytecode can be generated; and object information indicating a plurality of application objects and, for individual of the application objects, object state information indicating a state of the individual application object at an execution state of the application; compiling, at the first computing system, the bytecode into machine code for execution by the first computing system; initializing, at the first computing system, a heap of a runtime with the plurality of application objects, individual of the application objects placed in a state indicated by the object state information for the individual application object; and executing, at the first computing system, the application in the runtime from the execution state via execution of the machine code.

Example 15 includes the subject matter of Example 14, and wherein the receiving the application snapshot comprises receiving the application snapshot from memory or storage local to the first computing system.

Example 16 includes the subject matter of Example 14, and wherein the application snapshot is received from a second computing system.

Example 17 includes the subject matter of Example 16, and further including sending a request for the application from the first computing system to the second computing system.

Example 18 includes the subject matter of Example 17, and wherein the request comprises information indicating the execution state of the application.

Example 19 includes the subject matter of Example 14, and wherein the application snapshot further comprises one or more runtime configuration settings, the method further comprising configuring a runtime within which the application is to execute based on the one or more runtime configuration settings.

Example 20 includes the method of any one of claims 14-19, the method further comprising saving the application snapshot to memory or storage local to the first computing system.

Example 21 includes a computing system comprising one or more processor units; and one or more computer-readable storage media storing computer-executable instructions that, when executed, cause the one or more processor units to perform the method of any one of claims 1-20.

Example 22 includes one or more computer-readable storage media storing computer-executable instructions that, when executed, cause a first computing system to perform the method of any one of claims 1-20.

Example 25 includes an apparatus comprising a means to perform any one of the method of claims 1-20.

1. A method comprising:
generating, at a first computing system, bytecode from source code of an application;
executing, at the first computing system, the bytecode to an execution state;
generating, at the first computing system an application snapshot comprising:
the bytecode; and
object information indicating a plurality of application objects created during execution of the bytecode and, for individual of the application objects, object state information indicating a state of the individual application object at the execution state;
receiving, at the first computing system, a request for the application from a second computing system; and
providing, from the first computing system, the application snapshot to the second computing system.

2. The method of claim 1, wherein the request comprises information indicating a requested execution state of the application, the providing the application snapshot being performed in response to the first computing system determining that the execution state matches the requested execution state.

3. The method of claim 1, wherein the execution state is a first execution state, the application snapshot is a first application snapshot, the object state information is first object state information indicating states of the individual application objects at the first execution state;
the method further comprising:
executing, at the first computing system, the bytecode to a second execution state;
generating, at the first computing system, a second application snapshot comprising:
the bytecode or information from which the bytecode can be generated; and
the object information indicating the plurality of application objects and, for individual of the application objects, second object information indicating a state of the individual application object at the second execution state; and
providing, from the first computing system, the second application snapshot to the second computing system.

4. The method of claim 3, further comprising receiving, from the second computing system, information indicating the second execution state, the executing the bytecode to the second execution state and the generating the second application snapshot being performed in response to receiving the information indicating the second execution state.

5. The method of claim 1, wherein the executing the bytecode is performed in a runtime configured according to one or more runtime configuration settings, the application snapshot further comprising information indicating at least one of the one or more runtime configuration settings.

6. The method of claim 5, wherein the runtime is a first runtime, the one or more runtime configuration settings are one or more first runtime configuration settings, the application snapshot is a first application snapshot comprising first object state information indicating states of the application objects in response to executing the bytecode in the first runtime to the execution state, the method further comprising:
executing, at the first computing system, the bytecode in a second runtime configured according to one or more second runtime configuration settings;
generating, at the first computing system, a second application snapshot comprising:
the bytecode or information from which the bytecode can be generated; and
the object information indicating the plurality of application objects and, for individual of the application objects, second object state information indicating a state of the individual application objects in response to executing the bytecode in the second runtime to the execution state; and
providing, from the first computing system, the second application snapshot to the second computing system.

7. The method of claim 6, wherein the request comprises information indicating one or more requested runtime configuration settings, the providing the first application snapshot being performed in response to the first computing system determining that the one or more requested runtime configuration settings match the first runtime configuration settings.

8. The method of claim 6, further comprising receiving, from the second computing system, information indicating the one or more second runtime configuration settings, the executing the bytecode in the second runtime and the generating the second application snapshot being performed in response to receiving the information indicating the one or more second runtime configuration settings.

9. A computing system comprising:
one or more processor units; and
one or more computer-readable storage media storing computer-executable instructions that, when executed, cause the one or more processor units to perform a method of:
generating bytecode from source code of an application;
executing the bytecode to an execution state;
generating an application snapshot comprising:
the bytecode; and
object information indicating a plurality of application objects created during execution of the bytecode and, for individual of the application objects, object state information indicating a state of the individual application object at the execution state;
receiving a request for the application from a remote computing system; and
providing the application snapshot to the remote computing system.

10. The computing system of claim 9, wherein the execution state is a first execution state, the application snapshot is a first application snapshot, the object state information is first object state information indicating states of the individual application objects at the first execution state;
the method further comprising:
executing the bytecode to a second execution state;
generating a second application snapshot comprising:
the bytecode or information from which the bytecode can be generated; and
the object information indicating the plurality of application objects and, for individual of the application objects, second object information indicating a state of the individual application object at the second execution state; and
providing the second application snapshot to the remote computing system.

11. The computing system of claim 10, the method further comprising receiving, from the remote computing system, information indicating the second execution state, the executing the bytecode to the second execution state and the generating the second application snapshot being performed in response to receiving the information indicating the second execution state.

12. The computing system of claim 9, wherein the executing the bytecode is performed in a runtime configured according to one or more runtime configuration settings, the application snapshot further comprising information indicating at least one of the one or more runtime configuration settings.

13. The computing system of claim 12, wherein the runtime is a first runtime, the one or more runtime configuration settings are one or more first runtime configuration settings, the application snapshot is a first application snapshot comprising first object state information indicating states of the application objects in response to executing the bytecode in the first runtime to the execution state, the method further comprising:
executing the bytecode in a second runtime configured according to one or more second runtime configuration settings;
generating a second application snapshot comprising:
the bytecode or information from which the bytecode can be generated; and
the object information indicating the plurality of application objects and, for individual of the application objects, second object state information indicating a state of the individual application objects in response to executing the bytecode in the second runtime to the execution state; and
providing, from the computing system, the second application snapshot to the remote computing system.

14. One or more computer-readable storage media storing computer-executable instructions that, when executed, cause a computing system to perform a method of:
generating bytecode from source code of an application;
executing the bytecode to an execution state;
generating an application snapshot comprising:
the bytecode; and
object information indicating a plurality of application objects created during execution of the bytecode and, for individual of the application objects, object state information indicating a state of the individual application object at the execution state;
receiving a request for the application from a remote computing system; and
providing the application snapshot to the remote computing system.

15. The one or more computer-readable storage media of claim 14, wherein the request comprises information indicating a requested execution state of the application, the providing the application snapshot being performed in response to the computing system determining that the execution state matches the requested execution state.

16. The one or more computer-readable storage media of claim 14, wherein the execution state is a first execution state, the application snapshot is a first application snapshot, the object state information is first object state information indicating states of the individual application objects at the first execution state;
the method further comprising:
executing the bytecode to a second execution state;
generating a second application snapshot comprising:
the bytecode or information from which the bytecode can be generated; and
the object information indicating the plurality of application objects and, for individual of the application objects, second object information indicating a state of the individual application object at the second execution state; and
providing the second application snapshot to the remote computing system.

17. The one or more computer-readable storage media of claim 16, the method further comprising receiving, from the remote computing system, information indicating the second execution state, the executing the bytecode to the second execution state and the generating the second application snapshot being performed in response to receiving the information indicating the second execution state.

18. The one or more computer-readable storage media of claim 16, wherein the executing the bytecode is performed in a runtime configured according to one or more runtime configuration settings, the application snapshot further comprising information indicating at least one of the one or more runtime configuration settings.

19. The one or more computer-readable storage media of claim 18, wherein the runtime is a first runtime, the one or more runtime configuration settings are one or more first runtime configuration settings, the application snapshot is a first application snapshot comprising first object state information indicating states of the application objects in response to executing the bytecode in the first runtime to the execution state, the method further comprising:
executing the bytecode in a second runtime configured according to one or more second runtime configuration settings;
generating a second application snapshot comprising:
the bytecode or information from which the bytecode can be generated; and
the object information indicating the plurality of application objects and, for individual of the application objects, second object state information indicating a state of the individual application objects in response to executing the bytecode in the second runtime to the execution state; and
providing the second application snapshot to the remote computing system.

20. The one or more computer-readable storage media of claim 19, the method further comprising receiving, from the remote computing system, information indicating the one or more second runtime configuration settings, the executing the bytecode in the second runtime and the generating the second application snapshot being performed in response to receiving the information indicating the one or more second runtime configuration settings.
